(19) United States
(12) Patent Application Publication
(10) Pub. No.: US 2015/0143358 A1
(43) Pub. Date: May 21, 2015

(54) CONFIGURATION AND INSTALLATION AUTOMATION

(71) Applicants: Brian L. McElmurry, Roseville, MN (US); Sandra G. Wierdsma, Roseville, MN (US); Edward J. Kujawa, Roseville, MN (US); Jerome G. Strobeck, Roseville, MN (US)

(72) Inventors: Brian L. McElmurry, Roseville, MN (US); Sandra G. Wierdsma, Roseville, MN (US); Edward J. Kujawa, Roseville, MN (US); Jerome G. Strobeck, Roseville, MN (US)

(73) Assignee: UNISYS CORPORATION, Blue Bell, PA (US)

(21) Appl. No.: 14/082,273

(22) Filed: Nov. 18, 2013

(51) Int. Cl. G06F 9/445; G06F 9/45

(52) U.S. Cl. CPC G06F 8/61; G06F 8/41; G06F 8/54
USPC 717/174

(57) ABSTRACT

A processor may be configured to process a first and second set of configuration statements. The processor may also be configured to at least partially rebuild a software product based, at least in part, on the processed first set of configuration statements. The processor may also install or reinstall the software product. The processing, rebuilding, and the installing or reinstalling features may be performed by a configuration and installation utility that can determine which steps need to be performed.

### FIELD OF DISCLOSURE

The instant disclosure relates to software products. More specifically, this disclosure relates to automated configuration and installation of software products.

### BACKGROUND

Conventional methods for configuring and installing software products and applications for the software products require numerous labor and time-intensive tasks to be performed prior to executing the product. Often, all the labor and time-intensive tasks must be performed for each new application, and if any changes are made to a configuration, all the tasks must be performed again manually.

### SUMMARY

The configuration and installation of software products may be enhanced by automating many of the tasks required to configure and install software products and by reducing the number of tasks that must be performed when changes are made to the configuration of an application or to code. For example, certain information may be obtained from the operating system, rather than prompting users to manually enter the information. As a result, the time and the labor required to configure and install software products and applications for the software products may be reduced.

According to one embodiment, a method may include processing, by a processor, a first set of configuration statements, and processing, by the processor, a second set of configuration statements. The method may also include at least partially rebuilding, by the processor, a software product based, at least in part, on the first set of configuration statements. The method may further include at least one of installing and reinstalling, by the processor, the software product.

According to another embodiment, a computer program product may include a non-transitory computer readable medium comprising code to perform the steps of processing a first set of configuration statements, and processing a second set of configuration statements. The medium may also include code to perform the step of at least partially rebuilding a software product based, at least in part, on the first set of configuration statements. The medium may further include code to perform the step of at least one of installing and reinstalling the software product.

According to a further embodiment, an apparatus may include a memory, and a processor coupled to the memory. The processor may be configured to execute the steps of processing a first set of configuration statements, and processing a second set of configuration statements. The processor may also be configured to execute the step of at least partially rebuilding a software product based, at least in part, on the first set of configuration statements. The processor may be further configured to execute the step of at least one of installing and reinstalling the software product.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating a method for automated configuration and installation of software products according to one embodiment of the disclosure.

FIG. 2 is a block diagram illustrating a computer network according to one embodiment of the disclosure.

FIG. 3 is a block diagram illustrating a computer system according to one embodiment of the disclosure.

FIG. 4A is a block diagram illustrating a server hosting an emulated software environment for virtualization according to one embodiment of the disclosure.

FIG. 4B is a block diagram illustrating a server hosting an emulated hardware environment according to one embodiment of the disclosure.

### DETAILED DESCRIPTION

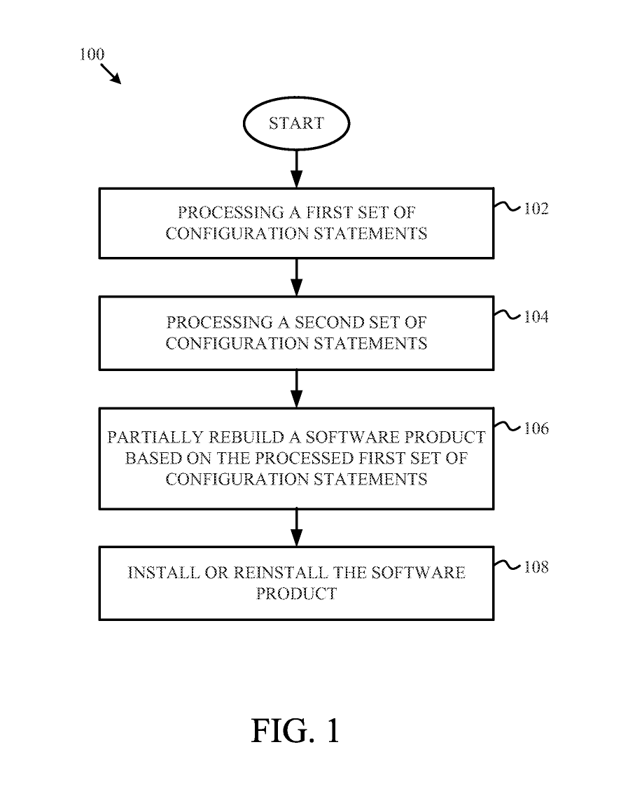

FIG. 1 is a flow chart illustrating a method for automated configuration and installation of software products according to one embodiment of the disclosure. A method 100 begins at block 102 with processing, for example by a processor, a first set of configuration statements. At block 104, a second set of configuration statements may be processed, for example, by the processor. The first and second sets of configuration statements may be associated with a software product received by the processor. One such software product may be, for example, a message-handling software product. Based, at least in part, on the processed first set of configuration statements, a software product may, at block 106, be partially rebuilt. According to one embodiment, partially rebuilding a software product may include recompiling a portion of the code associated with the software product, and at least one of linking and relinking the software product. For example, in some embodiments, after a portion of the code associated with the software product has been recompiled, one or more references to data items or entry points to routines may be undefined. In one embodiment, if the one or more references were previously linked to one or more definitions, then the software product may be relinked. According to another embodiment, if the one or more references were not previously linked to one or more definitions, then the software product may be linked so as to link the one or more references to one or more definitions for the reference. At block 108, the software product may be installed and/or reinstalled, for example, by the processor. For example, in one embodiment, if the software product has been previously installed, then the software product may be reinstalled at block 108. According to another embodiment, if the software product has not been previously installed, then the software product may be installed at block 108.

In some embodiments, the steps of processing the first set of configuration statements, processing the second set of configuration statements, partially rebuilding, and installing and/or reinstalling from blocks 102-108 may be automated and may be performed by a configuration and installation program known as a configuration and installation utility (CIU). The CIU may be a single utility that performs the operations at blocks 102-108, or the CIU may be multiple utilities that can be combined to perform the operations at blocks 102-108. According to one embodiment, each of the operations performed by the CIU may be automated, and performed automatically upon starting the CIU. In another embodiment, each of the operations performed by the CIU may be manually performed or initiated by a user. In some embodiments, before the CIU is invoked to partially rebuild the software product, the software product may have previously been fully built at least once.

By performing the operations at blocks 102-108 with an automated CIU, ease-of-use of the software product may be improved and the time devoted to configuring and/or installing a software product may be reduced, For example, according to one embodiment, a change to the first set of configuration statements may require some code associated with the software product to be changed and rebuilt, while the second set of configuration statements may be changed without affecting any of the code associated with the software product, wherein the at least partially rebuilding, such as at block 106, is in response to the change in the first set of configuration statements. Therefore, if the software product is already installed, and changes are made to the second set of configuration statements without making any changes to the first set of configuration statements, then the CIU may be used to, in some embodiments, perform at least only the operations at block 104 without requiring that the software product be rebuilt or reinstalled. That is, a subset of operations performed at blocks 102-108 may be performed in response to a change to the second set of configuration statements with no change to the first set of configuration statements, where the subset of operations performed at blocks 102-108 may be the processing of the second set of configuration statements at block 104. By reducing the number of steps that must be performed when some changes are made, the time and labor associated with configuring and installing a software product in different applications may be minimized. According to another embodiment, if the software product has not been installed, a new instance of the software product is to be installed, changes have been made to the first set of configuration statements, or corrections and/or upgrades to the software product are to made, then the CIU may be used to perform all the operations 102-108 of method 100.

According to an embodiment, the first set of configuration statements may include configuration statements that are built into a software product. Therefore, if a change is made to a configuration statement built into a software product, then the software product may be at least partially rebuilt and at least one of installed and reinstalled for the configuration changes specified by the configuration statement to be effective. In some embodiments, configuration statements within the first set of configuration statements may relate to the installation of a software product.

According to one embodiment, the second set of configuration statements may include configuration statements that are not built into a software product. Therefore, a change to a configuration statement not built into a software product may become effective without the need to rebuild and at least one of install and reinstall the software product.

In addition to the features described above, a CIU may include numerous other features that further improve the ease-of-use of the software product and further reduce the time devoted to configuring and/or installing a software product. For example, to reduce the time needed to process configuration statements, a CIU may save the first and second sets of configuration statements to a file in a form readable by the software product. As an example, a processor running the CIU may copy a plurality of files from the software product. Even though the software product may be installed in several applications, the processor may, in one embodiment, copy the plurality of files from the software product only once. In another embodiment, the processor may copy the plurality of files from the software product more than once.

A CIU may also be used to modify an application-specific configuration for the software product. For example, the processor running the CIU may create an application-specific configuration for the software product based, at least in part, on the copied plurality of files. In some embodiments, a prior version of the application-specific configuration may exist, and therefore the processor may convert an old application-specific configuration for the software product to a new application-specific configuration for the software product to modify the application-specification configuration for the software product.

In some embodiments, the processor running the CIU may also obtain information automatically from an operating system. In another embodiment, the processor may request that a user provide some of the information. The obtained information may, in some embodiments, be the saved first and second sets of configuration statements. In yet additional embodiments, the CIU may combine a plurality of executable programs into a modifiable sequence of linked statements. The modifiable sequence of linked statements may form a self-contained unit of work. By combining a plurality of executable programs into a modifiable sequence of linked statements, users may have the option to modify the programs if they desire.

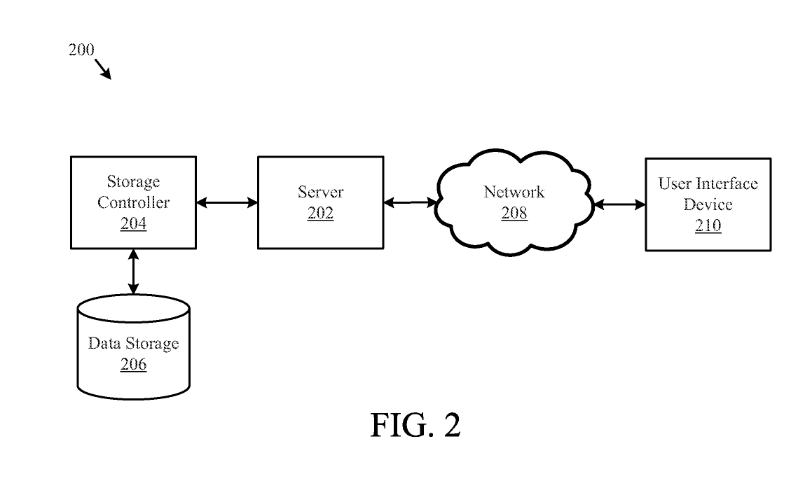

FIG. 2 illustrates one embodiment of a system 200 for an information system, including a system for automating configuration and installation of computer network software products. The system 200 may include a server 202, a data storage device 206, a network 208, and a user interface device 210. The server 202 may also be a hypervisor-based system executing one or more guest partitions hosting operating systems with modules having server configuration information. In a further embodiment, the system 200 may include a storage controller 204, or a storage server configured to manage data communications between the data storage device 206 and the server 202 or other components in communication with the network 208. In an alternative embodiment, the storage controller 204 may be coupled to the network 208.

In one embodiment, the user interface device 210 is referred to broadly and is intended to encompass a suitable processor-based device such as a desktop computer, a laptop computer, a personal digital assistant (PDA) or tablet computer, a smartphone or other mobile communication device having access to the network 208. When the device 210 is a mobile device, sensors (not shown), such as a camera or accelerometer, may be embedded in the device 210. When the device 210 is a desktop computer the sensors may be embedded in an attachment (not shown) to the device 210. In a further embodiment, the user interface device 210 may access the Internet or other wide area or local area network to access a web application or web service hosted by the server 202 and may provide a user interface for enabling a user to enter or receive information.

The network 208 may facilitate communications of data between the server 202 and the user interface device 210. The network 208 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

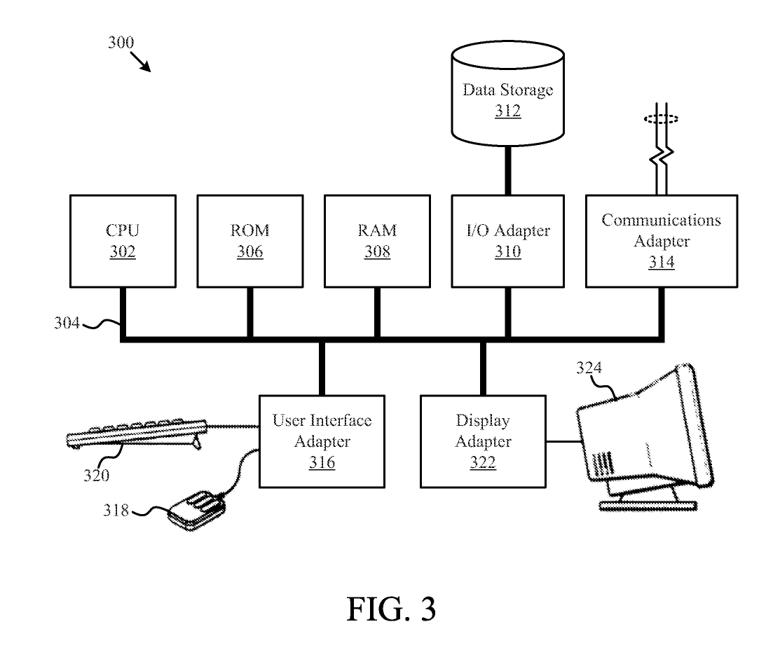

FIG. 3 illustrates a computer system 300 adapted according to certain embodiments of the server 202 and/or the user interface device 210. The central processing unit (“CPU”) 302 is coupled to the system bus 304. The CPU 302 may be a general purpose CPU or microprocessor, graphics processing unit (“GPU”), and/or microcontroller. The present embodiments are not restricted by the architecture of the CPU 302 so long as the CPU 302, whether directly or indirectly, supports the operations as described herein. The CPU 302 may execute the various logical instructions according to the present embodiments.

The computer system 300 also may include random access memory (RAM) 308, which may be synchronous RAM (SRAM), dynamic RAM (DRAM), synchronous dynamic RAM (SDRAM), or the like. The computer system 300 may utilize RAM 308 to store the various data structures used by a software application. The computer system 300 may also include read only memory (ROM) 306 which may he PROM, EPROM, EEPROM, optical storage, or the like. The ROM may store configuration information for booting the computer system 300. The RAM 308 and the ROM 306 hold user and system data, and both the RAM 308 and the ROM 306 may be randomly accessed.

The computer system 300 may also include an input/output (I/O) adapter 310, a communications adapter 314, a user interface adapter 316, and a display adapter 322. The I/O adapter 310 and/or the user interface adapter 316 may, in certain embodiments, enable a user to interact with the computer system 300. In a further embodiment, the display adapter 322 may display a graphical user interface (GUI) associated with a software or web-based application on a display device 324, such as a monitor or touch screen.

The I/O adapter 310 may couple one or more storage devices 312, such as one or more of a hard drive, a solid state storage device, a flash drive, a compact disc (CD) drive, a floppy disk drive, and a tape drive, to the computer system 300. According to one embodiment, the data storage 312 may be a separate server coupled to the computer system 300 through a network connection to the I/O adapter 310. The communications adapter 314 may be adapted to couple the computer system 300 to the network 208, which may be one or more of a LAN, WAN, and/or the Internet. The user interface adapter 316 couples user input devices, such as a keyboard 320, a pointing device 318, and/or a touch screen (not shown) to the computer system 300. The display adapter 322 may be driven by the CPU 302 to control he display on the display device 324. Any of the devices 302-322 may be physical and/or logical.

The applications of the present disclosure are not limited to the architecture of computer system 300. Rather the computer system 300 is provided as an example of one type of computing device that may be adapted to perform the functions of the server 202 and/or the user interface device 210. For example, any suitable processor-based device may be utilized including, without limitation, personal data assistants (PDAs), tablet computers, smartphones, computer game consoles, and multi-processor servers. Moreover, the systems and methods of the present disclosure may be implemented on application-specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 300 may be virtualized for access by multiple users and/or applications.

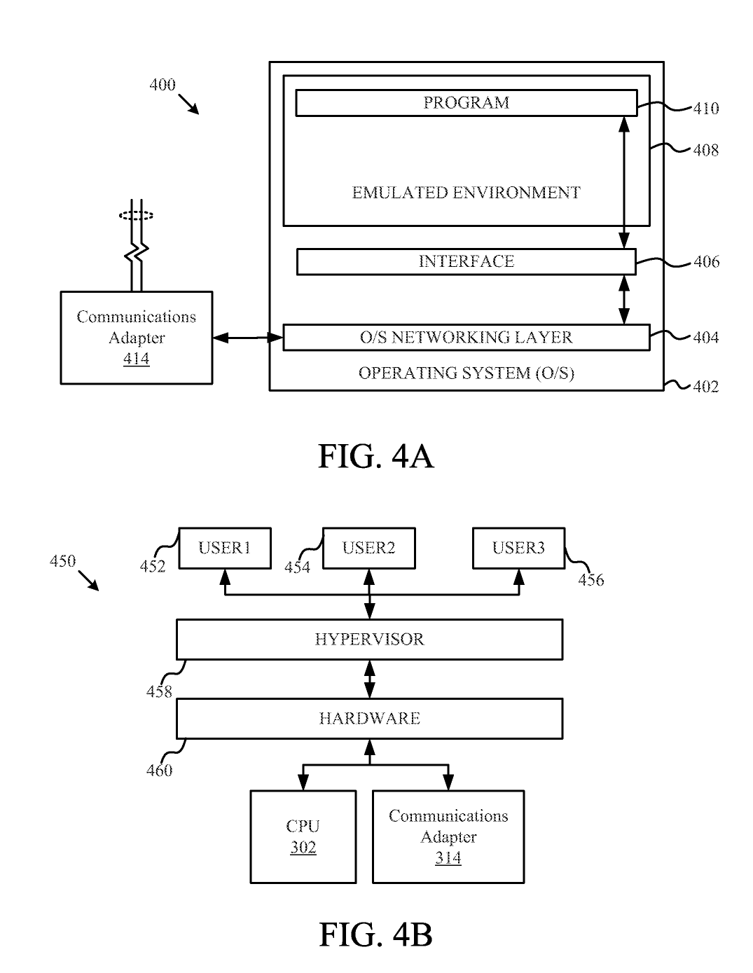

FIG. 4A is a block diagram illustrating a server hosting an emulated software environment for virtualization according to one embodiment of the disclosure. An operating system 402 executing on a server includes drivers for accessing hardware components, such as a networking layer 404 for accessing the communications adapter 414. The operating system 402 may be, for example, Linux. An emulated environment 408 in the operating system 402 executes a program 410, such as Communications Platform (CPComm) or Communications Platform for Open Systems (CPCommOS). The program 410 accesses the networking layer 404 of the operating system 402 through a non-emulated interface 406, such as extended network input output processor (XNIOP). The non-emulated interface 406 translates requests from the program 410 executing in the emulated environment 408 for the networking layer 404 of the operating system 402.

In another example, hardware in a computer system may be virtualized through a hypervisor. FIG. 4B is a block diagram illustrating a server hosting an emulated hardware environment according to one embodiment of the disclosure. Users 452, 454, 456 may access the hardware 460 through a hypervisor 458. The hypervisor 458 may be integrated with the hardware 460 to provide virtualization of the hardware 460 without an operating system, such as in the configuration illustrated in FIG. 4A. The hypervisor 458 may provide access to the hardware 460, including the CPU 302 and the communications adaptor 314.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines manufacture, compositions of matter, means, methods, or steps.

What is claimed is:

1. A method, comprising:
processing, by a processor, a first set of configuration statements;
processing, by the processor, a second set of configuration statements;
at least partially rebuilding, by the processor, a software product based, at least in part, on the processed first set of configuration statements; and
at least one of installing and reinstalling, by the processor, the software product.

2. The method of claim 1, in which a change to the first set of configuration statements requires some code associated with the software product to be changed and rebuilt while the second set of configuration statements can be changed without affecting any of the code associated with the software product, wherein the at least partially rebuilding is in response to the change in the first set of configuration statements.

3. The method of claim 1, in which the at least partially rebuilding comprises:
recompiling a portion of the code associated with the software product; and
at least one of linking and relinking the software product.

4. The method of claim 1, further comprising:
saving the second set of configuration statements to a file in a form readable by the software product;
obtaining information automatically from an operating system; and
combining a plurality of executable programs into a modifiable sequence of linked statements that form a self-contained unit of work.

5. The method of claim 1, in which the steps of processing the first set of configuration statements, processing the second set of configuration statements, at least partially rebuilding, and at least one of installing and reinstalling are automated and are performed by a configuration and installation utility (CIU).

6. The method of claim 1, further comprising modifying an application-specific configuration for the software product by converting an old application-specific configuration for the software product to a new application-specific configuration for the software product.

7. The method of claim 1, in which at least one of the steps is performed in response to a change to the second set of configuration statements and no change to the first set of configuration statements, the step comprising at least processing the second set of configuration statements.

8. A computer program product, comprising:
a non-transitory computer readable medium comprising code to perform the steps of:
processing a first set of configuration statements;
processing a second set of configuration statements;
at least partially rebuilding a software product based, at least in part, on the processed first set of configuration statements; and
at least one of installing and reinstalling the software product.

9. The computer program product of claim 8, in which a change to the first set of configuration statements requires some code associated with the software product to be changed and rebuilt while the second set of configuration statements can be changed without affecting any of the code associated with the software product, wherein the at least partially rebuilding is in response to the change in the first set of configuration statements.

10. The computer program product of claim 8, in which the at least partially rebuilding comprises:
recompiling a portion of the code associated with he software product; and
at least one of linking and relinking the software product.

11. The computer program product of claim 8, in which he medium further comprises code to perform the steps of:
saving the second set of configuration statements to a file in a form readable by the software product;
obtaining information automatically from an operating system; and
combining a plurality of executable programs into a modifiable sequence of linked statements that form a self-contained unit of work.

12. The computer program product of claim 8, in which the steps of processing the first set of configuration statements, processing the second set of configuration statements, at least partially rebuilding, and at least one of installing and reinstalling are automated and are performed by a configuration and installation utility (CIU).

13. The computer program product of claim 8, in which the medium further comprises code to perform the step of modifying an application-specific configuration for the software product by converting an old application-specific configuration for the software product to a new application-specific configuration for the software product.

14. The computer program product of claim 8, in which at least one of the steps are performed in response to a change to the second set of configuration statements and no change to the first set of configuration statements, the step comprising at least processing the second set of configuration statements,

15. An apparatus, comprising:
a memory; and
a processor coupled to the memory, the processor configured to execute the steps of:
processing a first set of configuration statements;
processing a second set of configuration statements;
at least partially rebuilding a software product based, at least in part, on the first set of configuration statements; and
at least one of installing and reinstalling the software product.

16. The apparatus of claim 15, in which a change to the first set of configuration statements requires some code associated with the software product to be changed and rebuilt while the second set of configuration statements can be changed without affecting any of the code associated with the software product, wherein the at least partially rebuilding is in response to the change in the first set of configuration statements, and in which at least one of the steps are performed in response to a change to the second set of configuration statements and no change to the first set of configuration statements, the step comprising processing the second set of configuration statements.

17. The apparatus of claim 15, in which the at least partially rebuilding comprises:
recompiling a portion of the code associated with the software product; and
at least one of linking and relinking the software product.

18. The apparatus of claim 15, in which the processor is further configured to perform the steps of:
saving the second set of configuration statements to a file in a form readable by the software product;
obtaining information automatically from an operating system; and
combining a plurality of executable programs into a modifiable sequence of linked statements that form a self-contained unit of work.

19. The apparatus of claim 15, in which the steps of processing the first set of configuration statements, processing the second set of configuration statements, at least partially rebuilding, and at least one of installing and reinstalling are automated and are performed by a configuration and installation utility (CIU).

20. The apparatus of claim 15, in which the processor is further configured to perform the step of modifying an application-specific configuration for the software product by converting an old application-specific configuration for the software product to a new application-specific configuration for the software product.
